(19) United States
(12) Patent Application Publication
(10) Pub. No.: US 2008/0270970 A1
(43) Pub. Date: Oct. 30, 2008

(54) Method for processing pattern data and method for manufacturing electronic device

(75) Inventor: Naomasa Shiraishi, Saitama-shi (JP)

Correspondence Address: STAAS & HALSEY LLP, SUITE 700, 1201 NEW YORK AVENUE, N.W., WASHINGTON, DC, 20005, US

(73) Assignee: NIKON CORPORATION, Tokyo (JP)

(21) Appl. No.: 12/078,178

(22) Filed: Mar. 27, 2008

Related U.S. Application Data
(60) Provisional application No. 60/924,061, filed on Apr. 27, 2007.

(51) Int. Cl. G06F 17/50

(52) U.S. Cl. 716/19

(57) ABSTRACT

A method for processing data for a mask pattern. The method includes analyzing data of the mask pattern and specifying a pattern region having a predetermined shape and a predetermined dimension from the mask pattern. The pattern region functions as an alignment mark.

### CROSS-REFERENCE TO RELATED APPLICATIONS

This application claims the benefit of U.S. Provisional Application No. 60/924,061, filed on Apr. 27, 2007.

### BACKGROUND OF THE INVENTION

The present disclosure relates to a method for processing pattern data for a mask pattern formed on a mask and a method for manufacturing an electronic device, and more particularly, to a technique effective for data generation of a photomask and alignment used to manufacture an electronic device such as a semiconductor element.

An electronic device such as an LSI is manufactured by overlapping tens of layers of circuit patterns on a substrate such as a silicon wafer, which serves as an exposed subject. The circuit pattern of each layer is formed in a lithography process that transfers a mask pattern drawn on a photomask (hereinafter also simply referred to as mask) onto a substrate with a projection exposure apparatus.

In each lithography process of the manufacturing process for an electronic device, accurate alignment between a circuit pattern existing on the substrate and a newly transferred pattern is extremely important. To this end, the position of a circuit pattern exposed onto the substrate in a previous lithography process must first be accurately detected.

Accordingly, as disclosed in patent document 1, in addition to the circuit pattern formed on the substrate, a photomask including an exclusive alignment mark that has a predetermined positional relationship with the circuit pattern is used in the prior art. In the lithography process, the alignment mark is exposed onto the substrate along with the circuit pattern. The position of the circuit pattern formed on the substrate is detected by measuring the position of the exclusive alignment mark formed on the substrate.

The alignment mark is generally arranged on the substrate in a region referred to as a street line having a width of about 50 μm to 120 μm and existing between adjacent integrated circuits.

[Patent Document 1] Japanese Laid-Open Patent Publication No. 2002-043211

### SUMMARY OF THE INVENTION

As described above, in the prior art, the alignment mark is arranged separately from the circuit pattern on the photomask. Thus, a layout design for arranging the alignment mark on the photomask is necessary.

Further, the arrangement of the alignment mark is limited to the region between adjacent integrated circuits. Thus, the degree of freedom for arrangement of the alignment mark is low, and arrangement of an alignment mark in a single integrated circuit is difficult.

The present disclosure provides a method for processing pattern data that specifies a region that is usable as an alignment mark based on design data for a mask pattern (e.g., circuit pattern) formed on the mask.

Further, the present disclosure provides a method for manufacturing an electronic device by accurately measuring the position of a mask pattern (e.g., circuit pattern) on the substrate without arranging an alignment mark separately from the mask pattern.

In one aspect, a pattern data processing method for processing design data of a mask pattern includes specifying a predetermined region as a pattern region based on the design data, with the predetermined region having a dimension that is larger than or equal to a first reference value in a first direction and a dimension that is larger than or equal to a second reference value in a direction intersecting the first direction based on the design data.

In a further aspect, a method for manufacturing an electronic device includes a first exposure step of forming a first mask pattern on an exposed subject, a pattern region specifying step of specifying a pattern region from design data of the first mask pattern using the above pattern data processing method, a position determining step of determining positional information of the first mask pattern formed on the exposed subject in the first exposure step using information related to the pattern region obtained in the pattern region specifying step, and a second exposure step of forming a second mask pattern on the exposed subject based on the positional information of the first mask pattern obtained in the position determining step.

In the pattern data processing method of one aspect of the present disclosure, a region that is usable as an alignment mark may be specified as a pattern region from design data of a mask pattern.

In the method for manufacturing an electronic device of the further aspect of the present disclosure, a pattern region on a substrate that is usable as an alignment mark is specified from design data of a first mask pattern formed in a first exposure step, or a previous exposure step, without arranging an alignment mark separately from the mask pattern, and positional information of the first mask pattern may be determined based on the pattern region.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a diagram showing an example of the structure of an embodiment of mask data processing;

FIG. 2 is a flowchart for specifying a pattern region BD from mask design data SF;

FIG. 3 is a diagram showing the mask design data SF laid out as a bitmap pattern 40;

FIG. 4 is a diagram illustrating the specific of a pattern region BD;

FIG. 5 is a diagram illustrating the specific of the pattern region BD;

FIG. 6 is a flowchart illustrating in detail part of the process of the flowchart shown in FIG. 2;

FIG. 7 is a flowchart for checking the pattern region BD;

FIG. 8(A) is a diagram showing a pattern region BD1 including a region FBD in which where data is 0, FIG. 8(B) is a diagram showing a process for excluding the region FBD from the pattern region BD1 of FIG. 8(A), and FIG. 8(C) is a diagram showing a pattern region BD2 of a largest rectangular region from which the region FBD is excluded;

FIG. 9 is a diagram illustrating the checking of a region in which the data is 0 in the pattern region BD;

FIG. 10 is a diagram illustrating a method for specifying a group of a whole pattern as a pattern region; and

FIG. 11 is a schematic diagram showing the structure of an exposure apparatus.

### DETAILED DESCRIPTION OF THE PREFERRED EMBODIMENTS

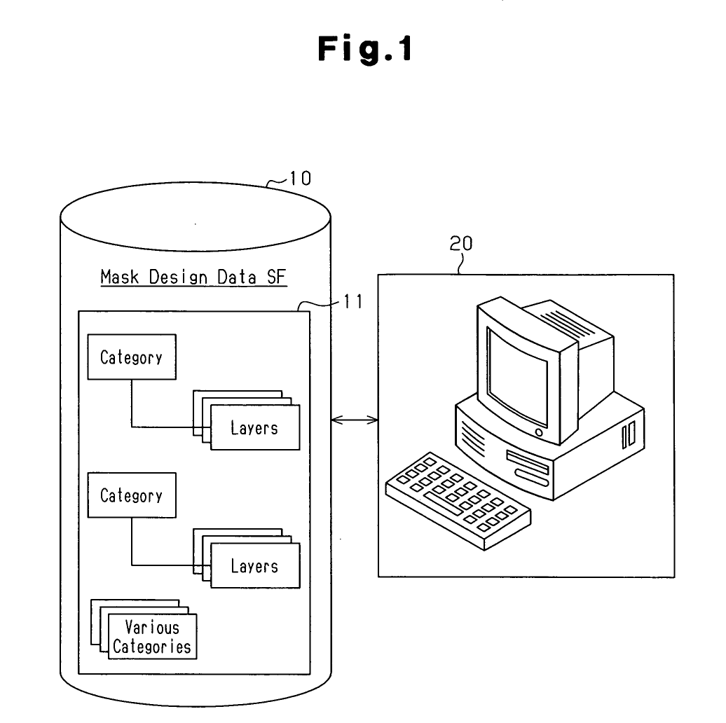

FIG. 1 shows one example of a preferable hardware structure for implementing a processing method of pattern data for processing pattern data (in the specification, also referred to as mask design data) of a mask pattern such as a circuit pattern formed on a mask and for specifying a predetermined region having a dimension, or a size, greater than or equal to a first reference value in a first direction and a dimension greater than or equal to a second reference value in a direction intersecting the first direction as a pattern region.

The mask design data, that is, pattern data for drawing a mask (mask drawing pattern data) is electronic information including positional information, shape information, and transmittance information of each pattern forming a circuit pattern that is to be formed on a photomask, which is used in a lithography process when manufacturing a semiconductor integrated circuit or the like.

The mask design data is not limited to mask drawing pattern data and may be pattern data used for a variable mask having a pattern of which the shape can be varied. The variable mask may have a structure in which a large number of microscopic windows, which can be opened and closed, are formed by liquid crystal on a glass substrate. The liquid crystal is driven to control the opening and closing of each aperture so as to display a desired circuit pattern on the glass substrate.

During the formation of a pattern on a photomask, the mask design data may be in bitmap data format (also referred to as raster data format) in which binary data is laid out in a bit map, with parts defining transmission portions being represented by the value of 1 and parts defining light shield portions being represented by the value of 0 (zero).

Further, the mask design data may be in a vector data format such as GDS2 format in which a pattern represented by the bitmap data format as described above is divided into a large number of microscopic polygons such as squares and triangles and the X and Y coordinate values of each vertex are written.

In this disclosure, a pattern represented in the bitmap data format is also referred to as bitmap pattern.

In FIG. 1, the mask design data SF of various mask patterns for manufacturing an electronic device such as semiconductor element is stored in a storage device 11 such as a hard disk of a data storage unit 10. The data storage unit 10 and a main computer 20 are connected through a network so that the mask design data SF is transferable between the storage device 11 of the data storage unit 10 and the main computer 20.

The mask design data SF corresponding to the layer of the necessary category in the mask design data SF is retrieved from the data storage unit 10 and sent to the main computer 20.

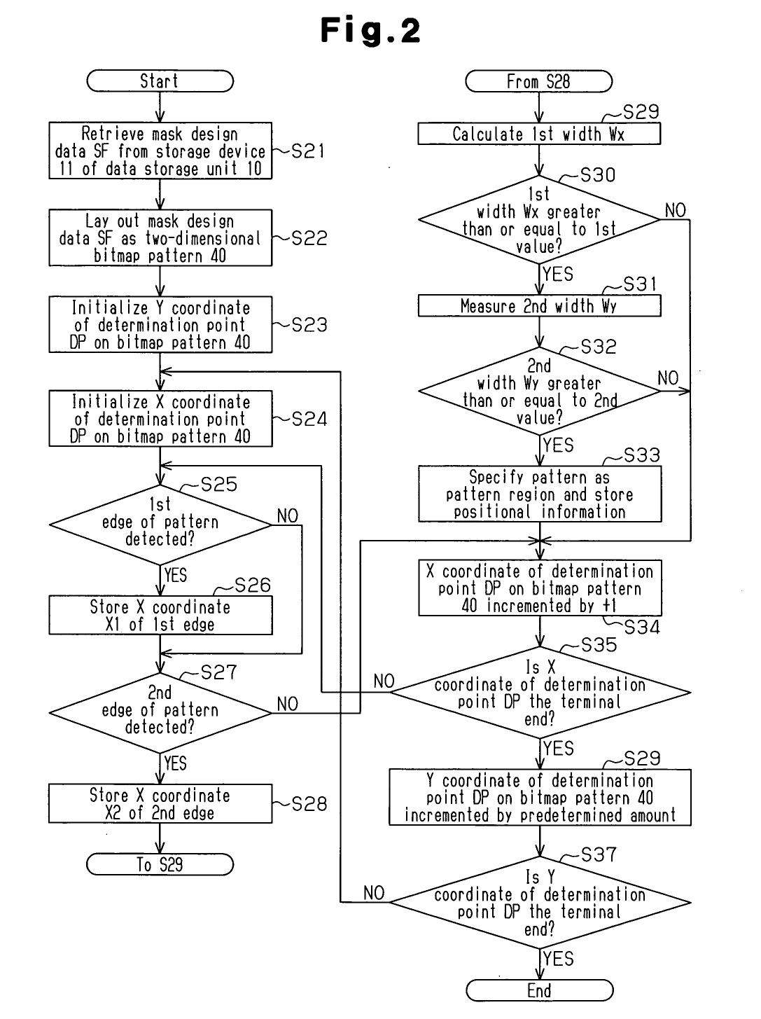

A first embodiment of a pattern data processing method which processes mask design data and specifies a predetermined region having a dimension greater than or equal to a first reference value in a first direction and a dimension greater than or equal to a second reference value in a direction intersecting the first direction as a pattern region will now be described with reference to FIGS. 2, 3, 4, and 7.

FIG. 2 is a flowchart showing one example of the pattern data processing method.

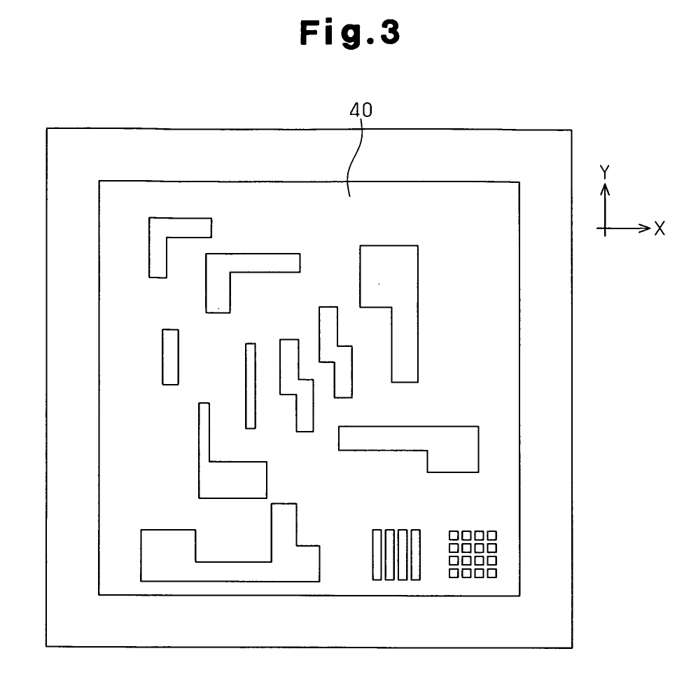

FIG. 3 is a diagram showing one example of a bitmap pattern laid out on a memory of the main computer 20 based on the mask design data SF.

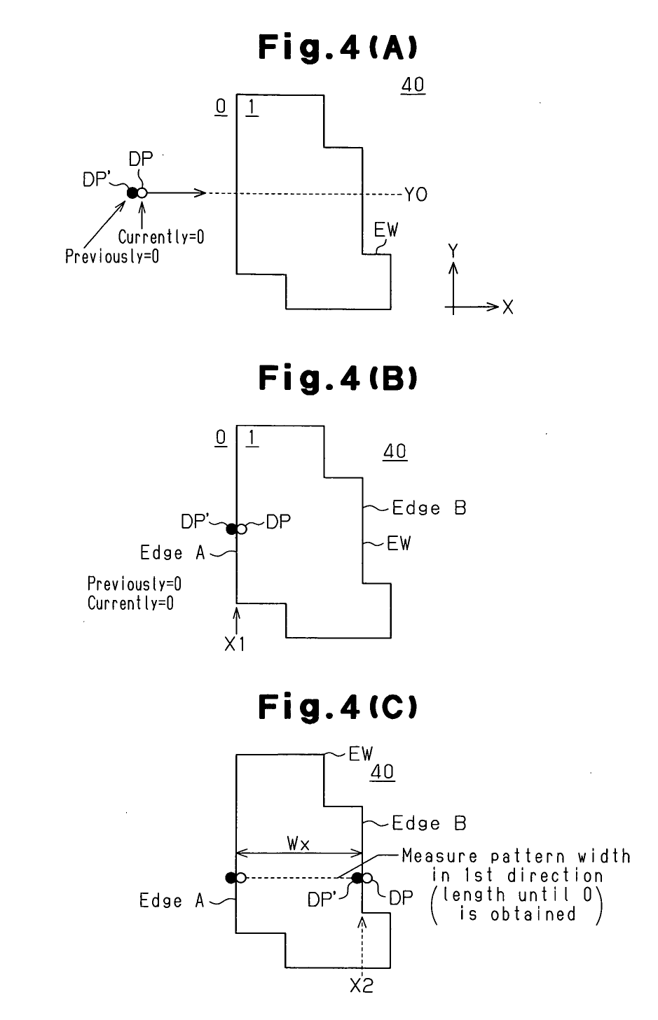

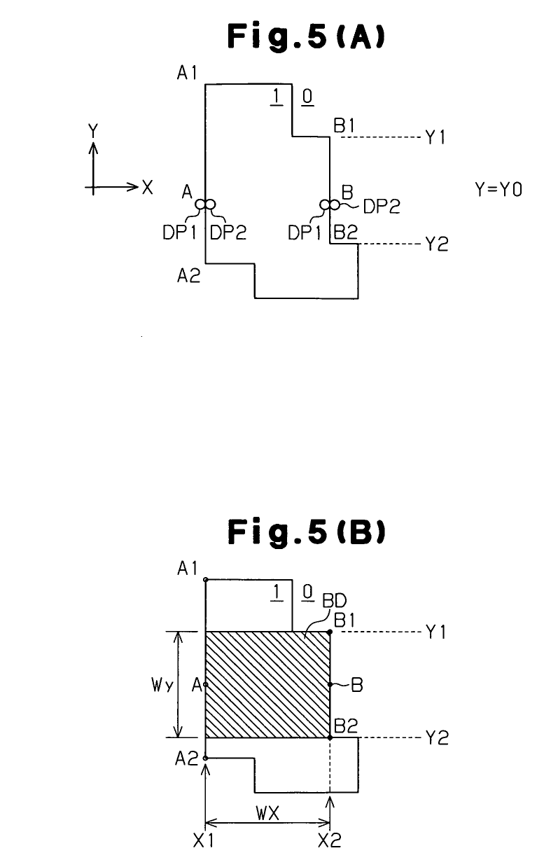

FIGS. 4 and 5 are partially enlarged views of the bitmap pattern laid out on the memory of the main computer 20 as shown in FIG. 3.

First, in step S21 of FIG. 2, the main computer 20 retrieves the mask design data SF from the storage device 11 of the data storage unit 10.

Next, in step S22, the main computer 20 lays out a two-dimensional binary bitmap pattern 40 as shown in FIG. 3 when the mask design data is in vector data format. In one example illustrated in FIG. 3, parts shown in gray indicate that the data value is 1, and parts shown in white indicate that the data value is 0.

Step S22 is not necessary if the mask design data SF is in bitmap data format.

Thereafter, a desired region is specified from the mask design data by scanning a determination point DP on the bitmap pattern 40. The scanning direction is the X direction in FIGS. 3 and 4 and also recognized as the first direction. The Y direction, which is orthogonal to the X direction, is recognized as the second direction.

In step S23, the main computer 20 initializes the Y coordinate of the determination point DP on the bitmap pattern 40. That is, the initial position of the determination point DP in the Y direction is set at, for example, the lower end in FIG. 3.

In step S24, the main computer 20 initializes the X coordinate of the determination point DP on the bitmap pattern 40. That is, the initial position of the determination point DP in the X direction is set at, for example, the left end in FIG. 3.

As hereinafter described, the main computer 20 sequentially increments the X coordinate of the determination point DP and moves the determination point DP in the +X direction on the bitmap pattern 40, as shown in FIGS. 3 and 4.

In step S25, the main computer 20 determines whether or not the determination point DP has been detected on a first edge of any pattern on the bitmap pattern 40.

The first edge is a portion where the data of the bitmap data 40 is 0 at a position adjacent to the edge in the −X direction and the data of the bitmap pattern 40 is 1 at a position adjacent to the edge in the +X direction.

The method for detecting the edge of a pattern in the bitmap pattern will now be described in detail with reference to FIG. 4.

FIG. 4(A) is a diagram showing the relationship between the determination point DP and the bitmap pattern 40 laid out on the memory of the main computer 20. The determination point DP sequentially moves, or scans, the bitmap pattern 40 in the +X direction while maintaining the Y coordinate value at Y0. In the state of FIG. 4(A), the previous value during the scanning operation, that is, the value of the adjacent determination point DP′ in the −X direction is 0, and the current value at the determination point DP is also 0. The main computer 20 does not determine that the determination point DP has traversed an edge of a pattern EW. That is, the main computer 20 does not determine that the edge of the pattern EW has been detected.

FIG. 4(B) is a diagram showing a state in which the determination point DP is further scanned in the +X direction so as to fall on one edge of the pattern EW. In this case, the previous value of the determination point DP′ during the scanning operation is 0, and the current value of the determination point DP is 1. Therefore, the main computer 20 detects that the determination point DP has traversed a first edge of the pattern EW. In this case, the process proceeds to step S26, and the main computer 20 stores the present X coordinate X1 of the determination point DP.

In step S27, the main computer 20 determines whether or not the determination point DP has detected a second edge of any pattern on the bitmap pattern 40.

The second edge is a portion where the data of the bitmap data 40 is 1 for the position adjacent in the −X direction and the data of the bitmap pattern 40 is 0 for the position adjacent in the +X direction.

In the state shown in FIG. 4(B), the determination point DP is not on the second edge.

However, if the determination point DP is further scanned in the +X direction as will be hereafter described, the determination point DP will fall on the second edge of the pattern EW as shown in FIG. 4(C). That is, in the state shown in FIG. 4(C), the value of the bitmap data 40 at the determination point DP is 0. Since the value at the previous determination point DP′ during the scanning operation is 1, the main computer 20 detects that the determination point DP has traversed the second edge of the pattern EW.

In this case, the process proceeds to step S28, and the main computer 20 stores the X coordinate X2 obtained by subtracting one from the X coordinate of the determination point DP. The process further proceeds to step S29, and a first width Wx in the X direction indicating a dimension of the pattern EW is calculated from the two detected X coordinates X1 and X2. The computer 20 calculates the difference between the X coordinates (X2-X1).

The process then proceeds to step S30, and the main computer 20 determines whether or not the first width Wx is greater than or equal to a first reference value. The details of the first reference value will be described later.

If the first width Wx is less than the first reference value, the process proceeds to step S34.

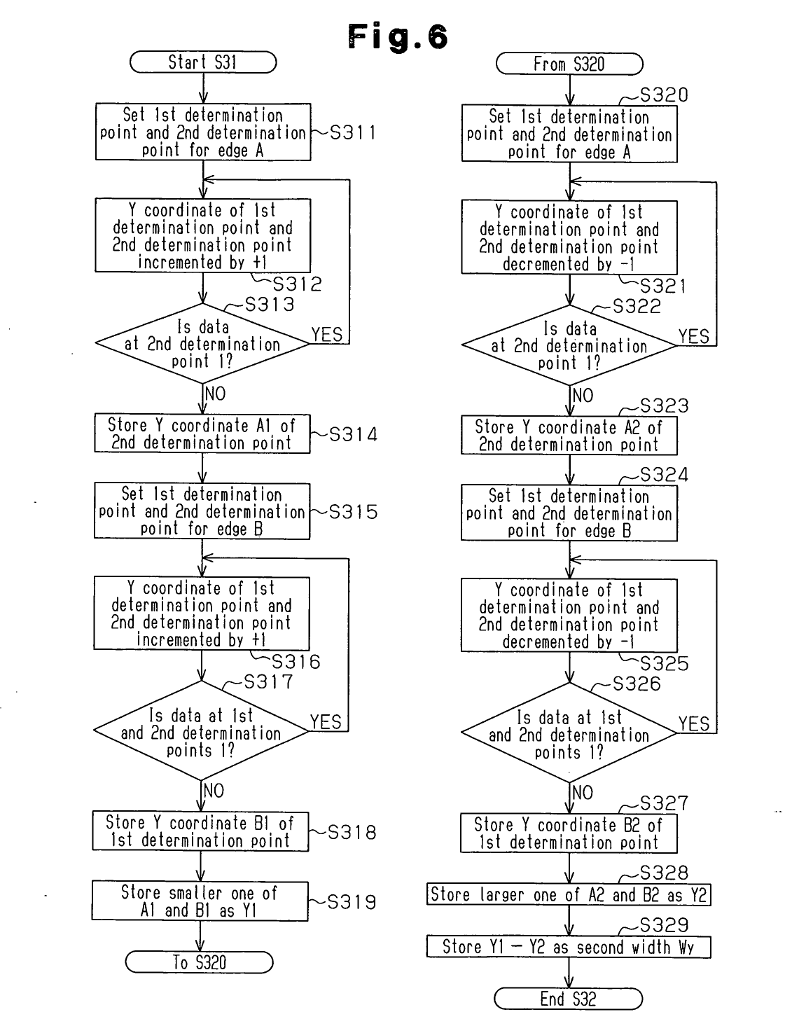

If the first width Wx is greater than or equal to the first reference value, the process proceeds to step S31, and a second width Wy in the Y direction (second direction) indicating a dimension of the pattern EW is measured. A method for measuring the second width Wy will now be described with reference to FIGS. 5 and 6.

In the same manner as FIG. 4, FIG. 5(A) is a diagram showing the pattern EW in the bitmap pattern 40 in an enlarged state. The process of step S25 and the process of step S27 has specified the first edge A and the second edge B along a line of which the Y coordinate value is Y0.

The process of step S31 will now be described in detail with the flowchart of FIG. 6.

In step S31, the main computer 20 first sets in sub-step S311 a first determination point DP1 in the −X direction of the first edge A and a second determination point DP2 in the +X direction of the first edge A. In sub-step S312, the Y coordinate of the first determination point DP1 and the second determination point DP2 is incremented (incremented by one). In sub-step S313, it is determined whether or not the value of the bitmap data 40 at the position of the second determination point DP2 is 1. If the value of the second determination point DP2 is 1, the first edge A is extended in the +Y direction, and the process returns to the sub-step S312. The value of the first determination point DP in the −X direction of the first edge A is always set to 0 in the pattern EW.

If the value of the second determination point DP2 is 0, the first edge A is assumed to be the terminal end in the +Y direction. Thus, the process proceeds to step S314, and the Y coordinate A1 of the current second determination point DP2 is stored.

In sub-step S315, the main computer 20 sets the first determination point DP1 for the second edge B in the −X direction and the second determination point DP2 for the second edge B in the +X direction. In sub-step S316, the Y coordinate of the first determination point DP1 and the second determination point DP2 is incremented (incremented by one). In sub-step S317, it is determined whether or not the values of the bitmap data 40 at the position of the first determination point DP1 and the second determination point DP2 are 1. If the value of the first determination point DP1 is 1 and the value of the second determination point DP2 is 0, the second edge B is extended in the Y direction and the process returns to the sub-step S316.

If the values of the first determination point DP1 and the second determination point DP2 are 0, the second edge B is assumed as being the terminal end in the +Y direction. Thus, the process proceeds to sub-step S318 and the Y coordinate B1 of the current determination point DP is stored.

In sub-step S319, the smaller one of A1 and B1 is stored as an upper end Y1 of the Y coordinate.

The process proceeds to sub-step S320, and the main computer 20 resets the first determination point DP1 for the first edge A in the −X direction and sets the second determination point DP2 for the first edge A in the +X direction. In sub-step S321, the Y coordinate of the first determination point DP1 and the second determination point DP2 is decremented (decreased by one). In sub-step S322, it is determined whether or not the value of the bitmap data 40 at the position of the second determination point DP2 is 1. If the value of the second determination point DP2 is 1, the first edge A is extended in the −Y direction and the process returns to sub-step S321. The value of the first determination point DP1 set for the first edge A in the −X direction is always 0 in the pattern EW.

If the value of the second determination point DP2 is 0, the first edge A is assumed as being the terminal end in the −Y direction. Thus, the process proceeds to sub-step S323 and the Y coordinate A2 of the current second determination point DP2 is stored.

In sub-step S324, the main computer 20 sets the first determination point DP1 for the second edge B in the −X direction and the second determination point DP2 for the second edge B in the +X direction. In sub-step S325, the Y coordinate of the first determination point DP1 and the second determination point DP2 is decremented (decreased by one). In sub-step S326, it is determined whether or not the values of the bitmap data 40 at the position of the first determination point DP1 and the second determination point DP2 are 1. If the value at the first determination point DP1 is 1 and the value at the second determination point DP2 is 0, the second edge B is extended in the Y direction and the process returns to sub-step S325.

If the values of the first determination point DP1 and the second determination point DP2 are 1, the second edge B is assumed as being the terminal end in the −Y direction. Thus, the process proceeds to sub-step S327 and the Y coordinate B2 of the current determination point DP is stored.

In sub-step S328, the larger one of A2 and B2 is stored as the lower end Y2 of the Y coordinate.

Finally, in sub-step S329, the difference between Y1 and Y2 is calculated as a second width Wy.

Subsequently, the process proceeds to step S32, and the main computer 20 determines whether or not the second width Wy is greater than or equal to a second reference value.

If the second width Wy is less than the second reference value, the process proceeds to step S34.

If the second width Wy is greater than or equal to the second reference value, the main computer 20 proceeds to step S33 and specifies a region of which X coordinates are included between X1 and X2 and Y coordinates are included between Y2 and Y1 as a pattern region BD, which is indicated by the shaded portion in FIG. 5(B).

In other words, the pattern region BD is, for example, a pattern in the mask design data or a partial region in the pattern and has a width in the first direction that is greater than or equal to the first reference value and a width in the second direction that is greater than or equal to the second value.

Such a pattern region BD has two ends in the X direction defined by a set of pattern edges parallel to the second direction (Y direction) and a width in the first direction (X direction) that is greater than or equal to the first reference value. The width is also greater than or equal to the second reference value in the Y direction.

Therefore, when such pattern region BD is drawn on the mask and then exposed and transferred onto an exposed subject such as wafer, the pattern region is used as a pattern for measuring a position in the X direction of the pattern formed on the exposed subject.

The main computer 20 stores information of the pattern region BD, that is, at least one of the coordinates for each vertex of the pattern region BD, in which the X coordinates are X1 and X2 and the Y coordinates are Y1 and Y2, the coordinates of the center of the pattern region BD, and the first width Wx and the second width Wy. Each piece of positional information may be stored in association with corresponding coordinates.

A plurality of pattern regions BD may be included in the mask design data. In such a case, after the specific of one pattern region BD, the specific of other pattern regions BD is continuously repeated.

Specifically, the process proceeds to step S34, and the main computer 20 increments (increases by one) the X coordinate for the determination point DP in the bitmap pattern 40. In step S35, the main computer 20 determines whether or not the X coordinate of the determination point DP falls on a terminal end, that is, the right end of the bitmap pattern 40 as viewed in FIG. 3.

If the X coordinate of the determination point DP has not fallen on the terminal end, the process returns to step S25, and the determination of a pattern edge is repeated again.

If the X coordinate of the determination point DP has fallen on the terminal end, the process proceeds to step S36, and a predetermined value is added to the Y coordinate of the determination point DP. The predetermined value may be one. The predetermined value may also be the value of the minimum line width of a pattern contained in the mask design data, which is the processed subject, or about half the minimum line width. The minimum line width may be input to the main computer 20 by an operator before initiating this process.

The process proceeds to step S37, and it is determined whether or not the Y coordinate of the determination point DP has fallen on the terminal end, that is, the upper end of the bitmap pattern 40 as viewed in FIG. 3.

If the Y coordinate of the determination point DP has not fallen on the terminal end, the process returns to step S24, and determination of the pattern edge is repeated again.

If the Y coordinate of the determination point DP has fallen on the terminal end, this indicates that the bitmap pattern 40 has been entirely processed. Thus, the process is terminated.

An example of the first reference value and the second reference value used to specify the pattern region BD in the above process will now be described.

As described above, the pattern region BD is formed on the mask as a mask pattern or part of a mask pattern that will subsequently be transferred onto an exposed subject such as a wafer. It is presumed that the position of the region corresponding to the pattern region BD transferred onto the exposed subject will be measured by a pattern position measurement system for an exposure apparatus or the like.

Accordingly, it is preferred that the pattern region BD have a dimension (width in X direction or Y direction) that is greater than or equal to the resolution of the pattern position measurement system of the exposure apparatus or the like when the pattern region BD is ultimately exposed and transferred onto the exposed subject.

An optical microscope having a numerical aperture of about 0.3 and a detection wavelength of 550 nm is used as an example of the position measurement system of the exposure apparatus for exposing and transferring the mask onto the exposed subject. The resolution corresponds to usage wavelength/numerical aperture, or 550 nm/0.3, and is about 1800 nm. The reduction ratio from the mask to the exposed subject such as a wafer is about four times. Thus, the pattern region BD preferably has a dimension that is greater than or equal to about 7 μm when converted on the mask.

Accordingly, it is preferable that the first reference value and the second reference value both be values corresponding to a level of 7 μm or greater than on the mask when the mask design data to be processed is drawn on the mask as a pattern.

Each pattern region BD specified as described above may include a region where the data of the bitmap pattern 40 is 0, that is, a region differing from the region where the data is 1.

Therefore, the following process is performed in addition to the above processing to exclude a region in which the data of the bitmap pattern 40 is 0 and determine a pattern region BD, that is, check the pattern region BD.

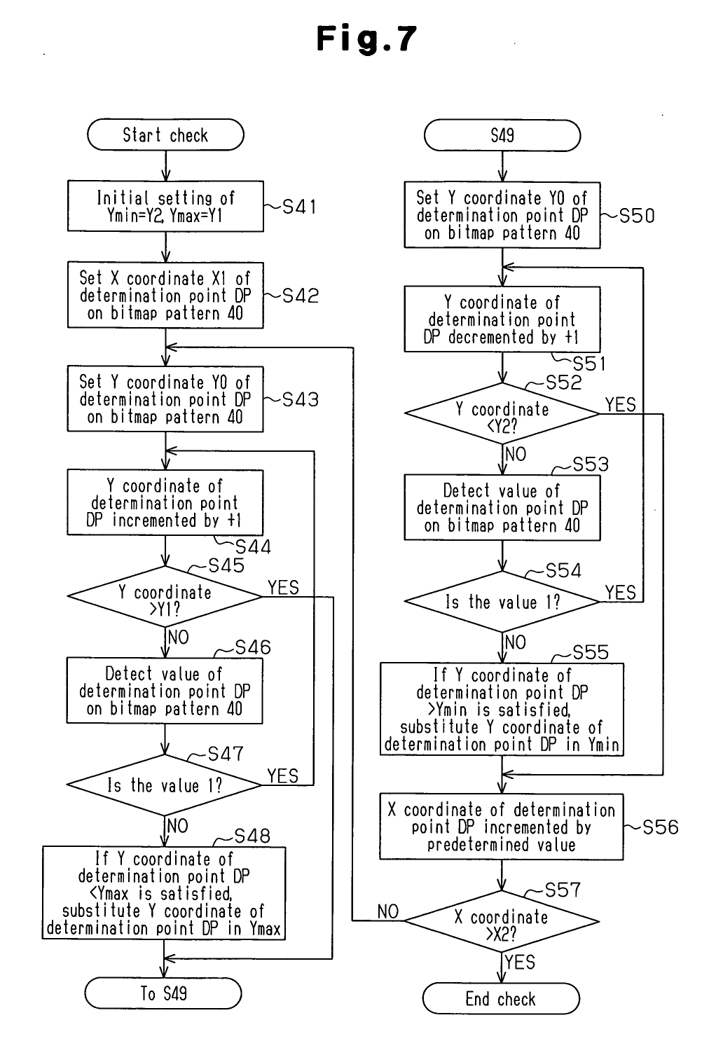

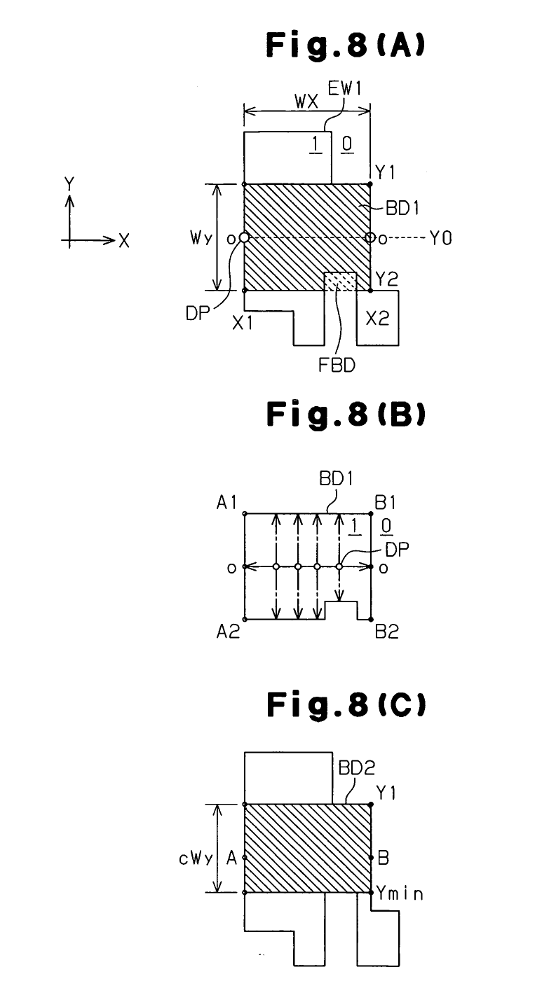

The checking method will now be described with reference to FIGS. 7 and 8.

FIG. 7 is a flowchart of a checking method, and FIG. 8 is a diagram showing a pattern region specified as described above. The pattern region BD1 includes a region FBD in which the data is 0.

First, in step S41, the main computer 20 assigns a variable Ymin and a variable Ymax to a register and respectively substitutes a lower limit value Y2 and an upper limit value Y1 of the Y coordinate of the pattern region BD1.

In step S42, the main computer 20 sets the X coordinate on the bitmap pattern 40 of the determination point DP to the lower limit value X1 of the X coordinate of the pattern region BD1. The process proceeds to step S43, and the main computer 20 sets the Y coordinate for the determination point DP in the bitmap pattern 40 to the Y coordinate Y0.

Subsequently, in step S44, the main computer 20 increments (increases by one) the Y coordinate for the determination point DP in the bitmap pattern 40. In step S45, it is determined whether or not the Y coordinate of the determination point DP is greater than the upper limit value Y1 of the pattern region BD1. If the Y coordinate is greater, the process proceeds to step S49.

If the Y coordinate of the determination point DP is less than or equal to the upper limit value Y1, the process proceeds to step S46, and the value of the bitmap pattern 40 at the position of the determination point DP is detected. In step S47, it is determined whether or not the value is 1, and the steps subsequent to step S44 are repeated if the value is 1.

If the value is not 1, that is, if the value is 0, the process proceeds to step S48. If the Y coordinate of the determination point DP is less than the variable Ymax in the register, the main computer 20 substitutes the Y coordinate of the determination point DP taken when the value of 0 is detected for the variable Ymax.

Thereafter, the process proceeds to step S49 and step S50, and the main computer 20 resets the Y coordinate for the determination point DP in the bitmap pattern 40 to the Y coordinate Y0 described above.

Subsequently, in step S51, the main computer 20 decrements (decreases by one) the Y coordinate of the determination point DP in the bitmap pattern 40. In step S52, it is determined whether or not the Y coordinate of the determination point DP is less than the lower limit value Y2 of the pattern region BD1. If the Y coordinate is smaller, the process proceeds to step S56.

If the Y coordinate of the determination point DP is greater than or equal to the lower limit value Y2, the process proceeds to step S53, and the value of the bitmap pattern 40 at the position of the determination point DP is detected. In step S54, it is determined whether or not the value is 1, and the steps subsequent to step S51 are repeated if the value is 1.

If the value is not 1, that is, if the value is 0, the process proceeds to step S55. If the Y coordinate of the determination point DP is less than the variable Ymin in the register, the main computer 20 substitutes the Y coordinate of the determination point DP taken when the value of 0 is detected for the variable Ymin. The process then proceeds to step S56, and the X coordinate of the determination point DP is incremented by a predetermined value. The predetermined value may be one. The predetermined value may also be a value of the minimum line width of a pattern contained in the mask design data, which is the processed subject, or about half the minimum line width.

Then, the process proceeds to step S57, and it is determined whether or not the X coordinate of the determination point DP is greater than the upper limit value X2 of the pattern region BD1. If the X coordinate of the determination point DP is less than or equal to the upper limit value X2, the steps subsequent to step S43 are repeated.

If the X coordinate of the determination point DP is greater than the upper limit value X2, the check is terminated.

FIG. 8(B) is a schematic diagram showing the operations from step S43 to step S57. That is, the determination point DP is sequentially moved on the pattern region BD1 of the bitmap pattern 40 in the Y direction and X direction, and an operation of detecting the presence of a region where the value of the bitmap pattern is 0 in the pattern region BD1 is performed.

As a result of the check, the corrected variable Ymin and the variable Ymax are stored in the main computer 20. The variables represent the lower limit value in the Y direction and the upper limit value in the Y direction of the largest rectangular region excluding the region FBD in which the value is 0 from the pattern region BD1.

In the case of the pattern EW1 and the pattern region BD1 shown in FIGS. 8(A) and 8(B), as a result of the check, the value of the variable Ymin is increased from Y2 but the value of the variable Ymax remains equal to Y1. The largest rectangular region excluding the region FBD where the value is 0 from the pattern region BD1 becomes a pattern region BD2 as shown by the shaded portion in FIG. 8(C).

The pattern region BD2 is newly specified in place of the pattern region BD1, and positional information of the pattern region BD2 is stored in place of the positional information of the pattern region BD1.

The above-described check may be performed after the processing of the mask design data shown in FIG. 2 is entirely terminated. Alternatively, the check may be performed before specifying the pattern region BD in step S33 of FIG. 2.

The method for specifying the pattern region described above is a method performed so that all values in the design data, that is, the mask design data of the bitmap pattern in the specified pattern region, are equal to one another and have a value of 1.

The pattern region BD is formed as a single region of a pattern of the mask and to be exposed and transferred onto an exposed subject, such as wafer. Among patterns formed on a wafer, the position of the portion corresponding to the pattern region BD on the wafer is assumed to be measured by the pattern position measurement system of the exposure apparatus and the like. Accordingly, the pattern region BD may include regions of different data (zero or one). If the dimensions of such a region when converted on the exposed subject is smaller than the resolution of a pattern position measurement system for an exposure apparatus or the like, accuracy of the measurement of the position is not adversely affected by such a region.

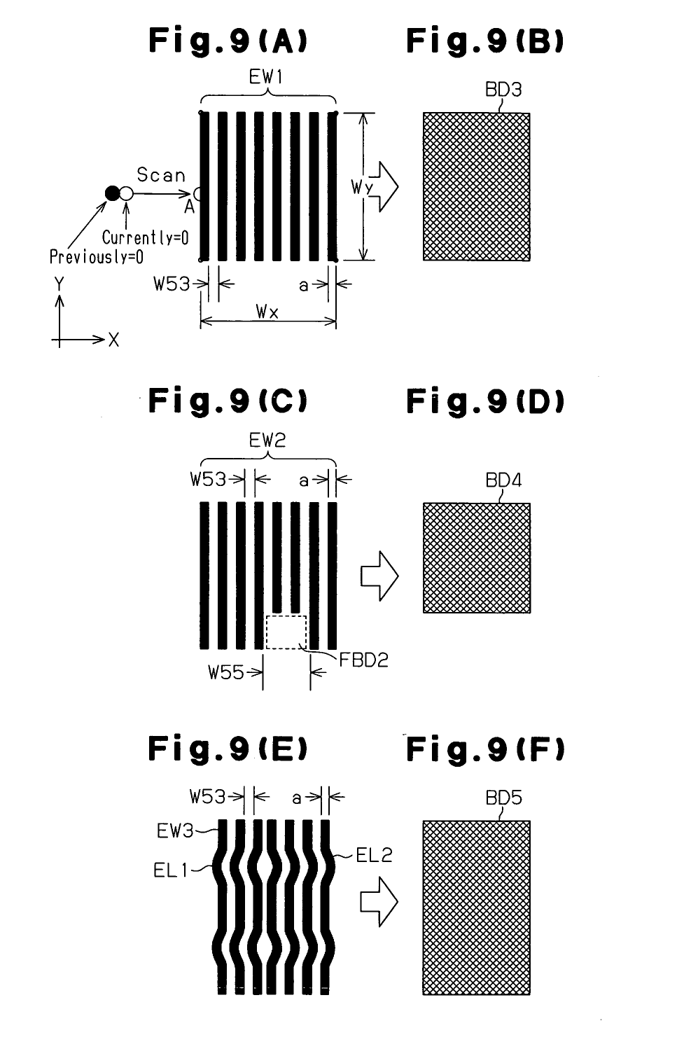

A method for specifying a pattern region BD that allows for a region in which the value of the mask design is 0 and a region in which the value of the mask design is 1 to be included will be described with reference to FIG. 9.

FIG. 9(A) is a diagram showing a bitmap pattern of a so-called line and space pattern EW1 in which a plurality of line patterns having line width a are laid out at an interval W53 in the X direction.

As described above, if the dimension of the interval W53 when converted on the exposed subject is small with respect to the resolution of the pattern position measurement system of the exposure apparatus or the like, the pattern EW1 can also be specified as a pattern region, and after being exposed and transferred, it can be used in measurement of the position of the pattern formed on the exposed subject.

A second embodiment for specifying the pattern EW1 as a pattern region will now be described with reference to FIG. 2.

The method of this example differs from the method of FIG. 2 only differ in the method of detecting the second edge in step S27. Thus, the description will be limited to this difference.

In the present example, when the second edge is detected in step S27, the determination point DP is scanned in the +X direction for a number of times corresponding to a third reference value while detecting for the first edge as in step S25. When the first edge is detected, it is assumed that the second edge has not been detected, and the process proceeds to step S34.

If the interval W53 is less than the third reference value, the line and space pattern EW1 is detected as if it is a pattern extending continuously in the X direction and is specified as a pattern region BD3 shown in FIG. 9(B).

The third reference value, when converted on the exposed subject, preferably has a dimension that is less than or equal to the resolution of the pattern position measurement system for an exposure apparatus. In other words, the third value is preferably less than or equal to about 7 μm when converted on the mask.

In this case, the first reference value and the second reference value are each preferably significantly larger than the third reference value. If it is not that large, adverse effects on a region in which the data is 0 becomes relatively large. This lowers the position measurement accuracy that uses the region of the exposed subject corresponding to the pattern region. The first reference value or the second reference value is preferably greater than, for example, five times the third reference value.

FIG. 9(C) is a diagram corresponding to the line and space pattern shown in FIG. 9(A) and shows a modified line and space pattern EW2 including a partial region FBD2 in which the data is 0.

Such a pattern EW2 may be specified as a pattern region by modifying the checking method of FIG. 7 in the second embodiment.

The modified checking method will now be described focusing on the difference from the above described checking method.

In the modified checking method, it is determined whether or not the value of the bitmap pattern 40 at the position of the determination point DP is 0 or 1 after incrementing the X coordinate of the determination point DP in step S56 of FIG. 7. If the value is 0, the determination point DP is located in an interval portion between the lines of the modified line and space pattern EW2. Thus, the X coordinate of the determination point DP is further incremented, and it is determined again whether or not the value of the bitmap pattern 40 at the position of the determination point DP is 0 or 1.

The incrementing of the X coordinate and the determination are repeated, and the process proceeds to step S57 when the value of the bitmap pattern 40 becomes 1.

As a result, part of the modified line and space pattern EW2 shown in FIG. 9(C) including the partial region FBD2 in which the data is 0 may also be specified as a pattern region BD4 as shown in FIG. 9(D).

As a modification of the line and space pattern, a pattern EW3 may have line patterns including partially curved lines, as shown in FIG. 9(E). In such a pattern, the two ends in the X direction are not parallel to the Y axis and this may not be suitable for use as a pattern for measuring a position in the X direction subsequent to exposure and transfer to a exposed subject. However, if a more suitable pattern does not exist, the pattern of the pattern EW3 in FIG. 9(E) must be specified as the pattern region.

In order to specify such a pattern as the pattern region, the process of step S31 in the pattern data processing method of the first embodiment and the second embodiment may be modified in the following manner.

When measuring the second width Wy in step S31, even if the X coordinates of the edge EL1 extending in the Y direction from the first edge detected in step S25 and the edge EL2 extending in the Y direction from the second edge detected in step S27 varies as the Y coordinate varies, the second width Wy is measured assuming that the Y direction edges are continuous if the variation of the X coordinates is within about half the minimum line width.

As a result, even for the pattern EW3 having line patterns with partially curved lines, as shown in FIG. 9(E), a pattern region BD5 may be specified as shown in FIG. 9(F).

In this case, the X coordinate X1 of the first edge stored in step S26 is preferably replaced with an average value of the X coordinates of the Y direction edge EL1, and the X coordinate X2 of the second edge stored in step S28 is preferably replaced with an average value of the X coordinates of the Y direction edge EL2.

The mask design data may contain a pattern that does not include a line pattern, or a so-called whole pattern. Such mask design data does not include a group of line patterns or a relatively large pattern. Thus, a pattern region cannot be specified with a group of line patterns or a relatively large pattern.

The group of the whole pattern needs to be specified as the pattern region from the mask design data.

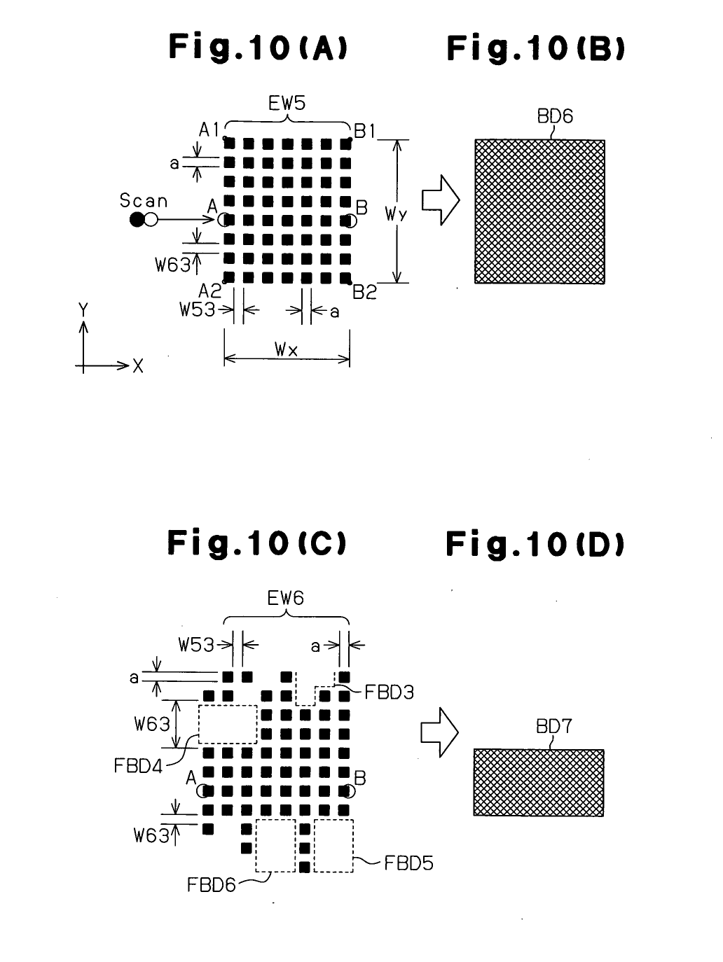

A modification of the processing method of the pattern data for specifying the group of the whole pattern as the pattern region will be described with reference to FIG. 10. FIG. 10(A) is a diagram showing a bitmap pattern including a group EW5 of whole patterns, which are microscopic square patterns. The whole pattern group EW5 includes seven lines of whole patterns in the X direction and eight lines of whole patterns in the Y direction. Each side of a whole pattern has a length represented by a, and the interval W63 between whole patterns is substantially equal to a.

The process of this modification is generally the same as the process of the second embodiment. Thus, only the differences will be described.

In this example, the processes in sub-step S312 and sub-step S313 of step S31 shown in detail in FIG. 6 are changed in the following manner. In sub-step S313, even if the value of the bitmap data 40 at the position of the determination point DP is 0, the processes of sub-step S312 and sub-step S313 are repeated for a number of times corresponding to the third reference value. The process proceeds to sub-step S314 to store the Y coordinate A1 of the determination point DP only if the value of the bitmap data 40 at the position of the determination point DP becomes 1 during the predetermined number of times.

The same changes as the changes made to sub-step S312 and sub-step S313 are made to sub-step S316 and sub-step S317, sub-step S321 and sub-step S322, and sub-step S325 and sub-step S326.

Thus, even for a pattern like the whole pattern group EW5, the pattern is detected as if it continuously extends in the Y direction if the interval W53 in the Y direction is less than the third reference value to be specified as a pattern region BD6, as shown in FIG. 10(B).

In this modified processing method, the modified checking method described above that excludes regions in which the data is 0 from a specified pattern region may be applied.

A pattern region BD7 shown in FIG. 10(D) may be specified from a group EW6 of whole patterns including regions FBD3, FBD4, FBD5, and FBD6 in which the data is 0, as shown in FIG. 10(C).

In each example of the above processing method, if more specified pattern regions BD are obtained than originally expected, a further preferable pattern region BD can be selected from the large number of pattern regions BD.

In such a case, for example, a predetermined number (e.g., about ten to hundred) of pattern regions BD may be selected from those having larger dimensions (width in the first direction or width in the second direction).

Alternatively, a predetermined number of pattern regions BD may be selected so that the pattern regions BD are distributed on the bitmap pattern 40 in a density that is as even as possible. More specifically, the bitmap pattern 40 may be divided into a predetermined number of sections in the X direction and in the Y direction (e.g., into eight to thirty sections), and a pattern region BD having the largest dimensions can be selected from each divided section.

In the above examples, the data processing is performed only on bitmap patterns of which background is 0 and pattern portion is 1. However, it is obvious that the present embodiment may be employed for bitmap patterns of which background is 1 and pattern portion is 0.

The pattern region BD determined as described above is a pattern having an edge parallel to the Y direction at both ends in the X direction or part of such a pattern. Thus, when formed in a mask and exposed and transferred onto the exposed subject such as wafer, the pattern region BD is a region suitable for the measurement of a position in the X direction. However, the relevant region is not necessarily a region suitable for measurement of the position in the Y direction.

The pattern region BD shown in FIG. 5(B) has an edge parallel to the Y direction at both ends in the X direction is thus shaped to be suitable for the measurement of a position in the X direction. However, if such pattern region is used to measure a position in the Y direction, the patterns (parts of pattern EW) at the two ends in the Y direction of the pattern region BD become obstacles. As a result, accurate position measurement becomes difficult.

Therefore, it is preferable that a pattern region suitable for the measurement of a position in the Y direction be separately specified from the specific of the pattern region suitable for the measurement of the position in the X direction. The specific of the pattern region suitable for the measurement of the position in the Y direction is performed by exchanging the X coordinates and the Y coordinates in each example of the processing method described above.

A pattern region can be specified as a mask pattern from patterns that have undergone an OPC (Optical Proximity Correction) process. Patterns that have undergone an OPC process include, for example, a mask pattern in which a correction pattern is added to a corner of the mask pattern or to a portion spaced from adjacent patterns by a predetermined interval or greater, a mask pattern that generates a correction pattern is generated based on a lithography simulator and experiment data, a mask pattern to which a “serif pattern” or “hammer head pattern” is added to preventing pattern corners from being rounded or a “bias” is added to correct line width variations of the pattern.

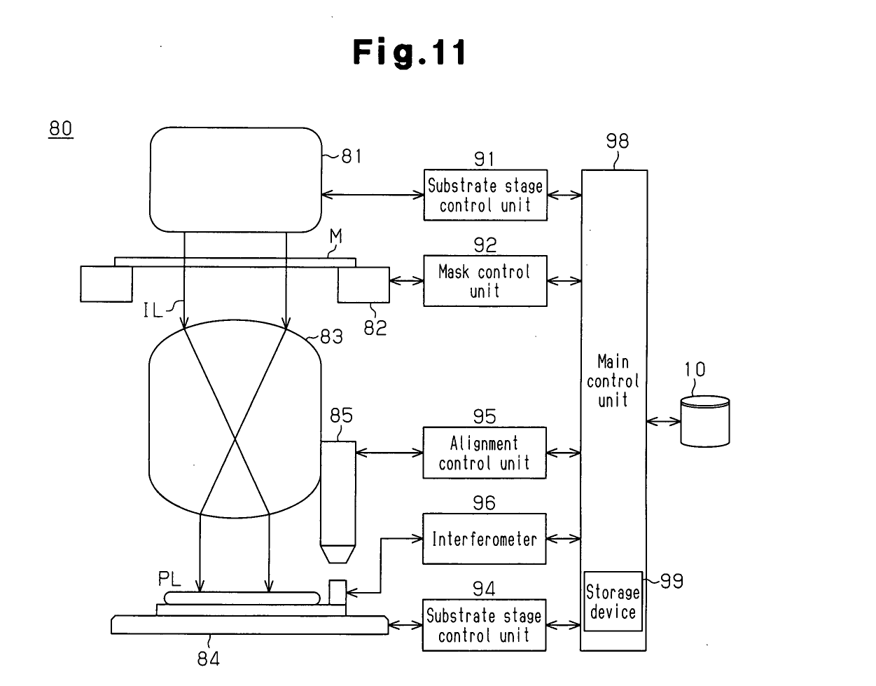

A first embodiment of a method for manufacturing an electronic device of the present invention will now be described with reference to FIG. 11.

FIG. 11 is a schematic diagram showing the structure of an exposure apparatus that is suitable for use in the method for manufacturing the electronic device of the present embodiment. An exposure apparatus 80 includes an illumination optical system 81, a mask stage 82, a projection optical system 83, a substrate stage 84, and a wafer alignment microscope 85, which is one example of a position measurement system. The exposure apparatus 80 projects a mask pattern of a mask M arranged on the mask stage 82 onto a wafer PL held on the substrate stage 84. The exposure apparatus 80 is capable of exposing the mask pattern onto the wafer PL with a resolution of 65 nm.

The wafer alignment microscope 85 is an optical microscope having a numerical aperture of, for example, 0.3, and the detection wavelength of the wafer alignment microscope 85 is about 550 nm.

The illumination optical system 81 includes a light source, a collimator lens, a fly's eye optical system, and the like, and irradiates the mask with ultraviolet light. The light source may be ArF laser, KrF laser, high pressure mercury lamp, and the like. A light source control unit 91 controls the light quantity of the light source, the lens movement of the illumination optical system, and the like.

The mask stage 82 supports the mask M and includes a mask control unit 92 for controlling the operation of the mask stage 82.

The projection optical system 83 projects the mask pattern of the mask M illuminated by the illumination light IL onto the wafer PL with an appropriate magnification (e.g., about 1/4 times).

The substrate stage 84 holds the wafer PL and moves the wafer PL relative to the projection optical system 83. A substrate stage control unit 94 drives the substrate stage 84 and performs step and repeat exposure. Further, the mask control unit 92 and the substrate stage control unit 94 synchronously move the substrate stage 84 and the mask stage 82 to perform step and scan exposure.

A movable mirror 86 is arranged on the substrate stage 84, and a laser interferometer 96 detects the position of the substrate stage 84 using the reflected light from the movable mirror 86 at an accuracy several nanometers or less. The XY coordinate of the pattern region BD of the mask pattern is detected from the detection result of the wafer alignment microscope 85 serving as the alignment optical system and the result of the position of the substrate stage 84 detected by the laser interferometer 96.

A main control unit 98 operates the illumination optical system 81 including the illumination light source, the mask stage 82, the projection optical system 83, the substrate stage 84, and the like at an appropriate timing to project the mask pattern onto the wafer PL at an appropriate location of. The main control unit 98 incorporates a storage unit 99, such as a hard disk, and communicates with the data storage unit 10.

When manufacturing an electronic device such as LSI, such an exposure apparatus is used to perform an exposure step of exposing and transferring the pattern of the mask M onto the wafer PL and the accompanying development step, etching step, film formation step, and the like repetitively for at least twenty times.

In the method for manufacturing the electronic device of the present embodiment, in at least one exposure step EXP1, a predetermined first mask pattern is initially exposed and transferred onto the wafer PL by using a first mask, which is formed from design data of the first mask pattern. The development step, the etching step, the film formation step, and the like are then performed.

Prior to or following the exposure step EXP1, a predetermined number of pattern regions are specified from the design data of the first mask pattern through the pattern data processing method described above. Then, the positional information or additionally the shape information of the pattern regions are stored in the data storage unit 10.

Subsequently, in an exposure step EXP2 performed after the exposure step EXP1, a second mask pattern is aligned with the first pattern, which is formed on the wafer PL, and then exposed and transferred using a second mask. In the exposure step EXP2, the positional information or the shape information of the pattern region are used to measure the position of the first mask pattern.

That is, the main control unit 98 of the exposure apparatus reads the positional information or the shape information of the pattern region specified from the design data of the first mask pattern stored in the data storage unit 10 through a data line or the like.

Both of the positional information and the shape information of the pattern region can be used in the measurement of the position of the first mask pattern.

Based on the information, the main control unit 98 of the exposure apparatus then specifies the position of the portion (hereinafter referred to as measuring target portion) corresponding to the pattern region in the first mask pattern formed on the wafer PL. The substrate stage is driven through the substrate stage control unit 94, a plurality of measuring target portions of the wafer PL is sequentially moved to the position of the wafer alignment microscope 85, and the position of such measuring target portions is measured.

Thereafter, the main control unit 98 of the exposure apparatus performs a statistical process, such as EGA, based on the measurement result of the position of the portion subject to measurement and determines the positional information of the first pattern formed on the pattern PL. The second pattern of the second mask is then aligned with the first mask pattern, which is formed on the wafer PL, based on the positional information and then exposed and transferred. Further, the development step, the etching step, the film formation step, and the like are performed. The positional information of the first mask pattern is information related to translation position, rotation, and extension in the wafer PL plane of the first mask pattern.

In the above example, the measurements for the position of the first mask pattern of the wafer PL are all performed on the portion subject to measurement. However, an exclusive alignment mark separate from the portion subject to measurement may also be measured. That is, at least one measurement subject portion may be measured together with the exclusive alignment mark.

Therefore, it is preferable that an exclusive alignment mark be formed separately from the first mask pattern on the first mask and be exposed and transferred onto the wafer PL in the exposure step EXP1.

It is preferable that the dimensions of the portion subject to measurement be set to be greater than or equal to the resolution of the wafer alignment microscope 85 as described above.

The present invention may be applied to each lithography process of a process for manufacturing an electronic device, such as a semiconductor integrated circuit LSI or liquid crystal display, and is industrially applicable.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all components disclosed in the embodiments. Further, components in different embodiments may be appropriately combined.

1. A pattern data processing method for processing design data of a mask pattern, the method comprising:
specifying a predetermined region as a pattern region based on the design data, with the predetermined region having a dimension that is larger than or equal to a first reference value in a first direction and a dimension that is larger than or equal to a second reference value in a direction intersecting the first direction.

2. The pattern data processing method according to claim 1, further comprising:
extracting a portion corresponding to a pattern edge based on the design data;
wherein said specifying a pattern region is performed based on at least one of positional information and shape information of the portion corresponding to the pattern edge.

3. The pattern data processing method according to claim 1, further comprising:
when a plurality of pattern regions are specified, selecting a predetermined number of pattern regions from the plurality of pattern regions.

4. The pattern data processing method according to claim 3, wherein said selecting a predetermined number of pattern regions is performed based on a positional relationship of the plurality of pattern regions in the design data.

5. The pattern data processing method according to claim 4, wherein said selecting the predetermined number of pattern regions is performed so that the predetermined number of pattern regions is distributed in the design data at a substantially even density.

6. The pattern data processing method according to claim 1, further comprising:
storing the positional information of the pattern region in the design data based on a result of the specifying.

7. The pattern data processing method according to claim 1, further comprising:
storing at least one of shape information related to the pattern region or information related to the dimensions of the pattern region in the design data based on a result of the specifying.

8. The pattern data processing method according to claim 1, further comprising:
storing positional information of the pattern region in the design data in association with at least one of the shape information related to the pattern region in the design data and information related to the dimensions of the pattern region based on a result of the specifying.

9. The pattern data processing method according to claim 1, wherein the predetermined region is a single region in which values of the design data are the same.

10. The pattern data processing method according to claim 1, wherein:
the predetermined region includes a first region and a second region, with values of the design data in the first region differing from values of the design data in the second region.

11. The pattern data processing method according to claim 10, wherein at least one of the dimension in the first direction of the first region and the dimension in the first direction of the second region is less than or equal to a third reference value.

12. The pattern data processing method according to claim 11, wherein the third reference value is less than or equal to five times the first reference value.

13. A method for manufacturing an electronic device, the method comprising:
forming a first mask pattern on an exposed subject;
specifying a pattern region from design data of the first mask pattern using the pattern data processing method according to claim 1;
determining positional information of the first mask pattern formed on the exposed subject using information related to the specified pattern region; and
forming a second mask pattern on the exposed subject based on the predetermined positional information of the first mask pattern obtained in the position.

14. The method for manufacturing an electronic device according to claim 13, wherein the determining includes measuring at least one pattern region corresponding to the pattern region formed on the exposed subject with a pattern position measurement system using the information related to the pattern region.

15. The method for manufacturing an electronic device according to claim 14, wherein the first reference value is converted to a dimension on the exposed subject and set to greater than or equal to a resolution of the pattern position measurement system.

16. The method for manufacturing an electronic device according to claim 14, wherein the second reference value is set to be greater than or equal to a resolution of the pattern position measurement system when converted to a dimension on the exposed subject.

17. The method for manufacturing an electronic device according to claim 14, wherein the third reference value is set to be less than or equal to a resolution of the pattern position measurement system when converted to a dimension on the exposed subject.
